(19) United States
(12) Patent Application Publication
(10) Pub. No.: US 2002/0120747 A1
(43) Pub. Date: Aug. 29, 2002

(54) System and method for maintaining constant buffering time in internet streaming media delivery

(76) Inventors: David J. Frerichs, Mountain View, CA (US); Jonathan Logan, Mountain View, CA (US); Eric Mason, Mountain View, CA (US)

Correspondence Address: CROCKETT & CROCKETT, 24012 CALLE DE LA PLATA, SUITE 400, LAGUNA HILLS, CA, 92653, US

(21) Appl. No.: 09/792,838

(22) Filed: Feb. 23, 2001

(51) Int. Cl. G06F 15/16; G06F 17/00

(52) U.S. Cl. 709/227; 709/231; 700/94

(57) ABSTRACT

A system and method for buffering streaming audio data or other media sources to client devices, where said system maintains a constant buffering time by adjusting the low water mark of the play buffer based on the bit rate of the stream to a level such that the time for the play buffer to fill to the low water mark is constant for all streams.

### FIELD OF THE INVENTIONS

The present invention relates generally to the field of world wide computer networks, and more particularly to transmission and reception of streaming media content from the internet.

### BACKGROUND OF THE INVENTIONS

Recently, radiobroadcasters have begun providing their audio content over the internet. Listeners can receive and play the audio content with a number of currently available devices. For example, a home listener can receive and play audio content or “netcasts” with a personal computer (“PC”) based device. The PC based devices generally include a PC, an internet account, a browser software such as Internet Explorer® or Netscape Navigator®, an audio processing software “plug-in” capable of processing audio information, and a radio simile graphical interface. Listeners can also receive and play netcasts with devices known as internet appliances. In our co-pending application, Internet Radio Receiver and Interface, U.S. application Ser. No. 09/334,846, we describe a radio receiver-like internet appliance having all of the necessary components needed to receive and play audio content over the internet.

Audio files provided by internet radiobroadcasters are typically large and if downloaded as a whole could take fifteen minutes of wait time for each one minute of audio play time. A process called streaming audio allows the user to listen to the audio continuously after a buffer is filled with audio data (as opposed to downloading the audio file and playing the file after the download is complete). A percentage of the streaming audio file is temporarily stored in the buffer before it is transferred for outputting. There is a number of streaming audio formats available. The common ones today include Real Networks G2 and G7, Microsoft Windows Media, Shoutcast MP3, and Icecast MP3.

When the user tunes to a particular internet radio station, the internet radio device must (a) establish a data connection with the station, (b) receive and fill the buffer to a low water mark with streaming audio data, and (c) start outputting the audio data at the head of the buffer while adding new audio data to the tail of the buffer when the buffer is filled to the low water mark. Step (b) is commonly called buffering or pre-buffering. Currently available internet radio devices set the low water mark at a constant size of audio data. Buffering to the low water mark may take on the order of several seconds. This multi-second gap (or dead air time) may be filled with silence and visually represented (when the streaming audio is received through the PC with a screen) with a small “progress bar” or message announcing how much of the buffering has been completed. On the internet appliance, it is difficult to communicate the progress of the buffering process since the internet appliance mimics the traditional radio receiver with no visual display. The dead air time can also be filled with an audio clip such as a pre-roll (described in our co-pending application, System and Method for Limiting Dead Air Time in Internet Streaming Media Delivery, application Ser. No. 09/570,837, filed May 12, 2000), advertisements, or other audio content.

When the user changes internet radio stations, the internet radio device must (a) establish a data connection with the new station, (b) receive and fill the buffer to the low water mark with streaming data from the new station, and (c) start playing the streaming data from the head of the buffered data while adding new streaming audio data to the tail of the buffered data when the buffer is filled to the low water mark.

The buffering time may vary from audio stream to audio stream depending on the user's connection quality to the network, network traffic, and the characteristics of the streaming audio to which the user is trying to connect. Particularly, the variance in buffering time is due to the fact that internet radio stations stream their audio content at different bit rates. For example, if the internet radio device is connected to a first radio station streaming at 128 kbps, it would take the internet radio device two (2) seconds to fill a buffer having a 256 kb low water mark. If the user switches to a second internet radio station streaming at 32 kbps, it would take the same device eight (8) seconds to buffer to the 256 kb low water mark.

If the buffering time is filled with silence, the variance in dead air time between various audio content sources diminishes the user's listening experience. This variance in dead air time is particularly problematic if the user is tuning with the internet appliance since it is difficult to communicate the buffering progress to the user. Furthermore, the variance in buffering time makes filling the buffering time with pre-rolls or other audio clip difficult. It would be difficult to predict if an audio clip will fill in a buffering time if the buffering time can vary from station to station.

### SUMMARY

The inventions described below provide a system and method for buffering streaming audio data. The system identifies the bit rate of the audio data. Once the bit rate is identified, the system adjusts the low water mark of the play buffer so that the period of time that the system spends buffering to the low water mark is equal to a constant buffering time. The system triggers an initial output when buffering to the low water mark. The consistent buffering time from audio source to audio source enhances the user's listening experience.

### BRIEF DESCRIPTION OF THE DRAWINGS

FIG. 1 is a block diagram of the system.

FIG. 2 is simplified diagram of the streaming media buffering process.

FIG. 3 is a simplified block diagram of a method of the internet appliance connecting to station IRQQ.

FIG. 4 is a simplified diagram of the system adjusting the low water mark of the play buffer.

FIG. 5 is a simplified diagram of the system adjusting the low water mark to a second radio station.

### DETAILED DESCRIPTION OF THE INVENTIONS

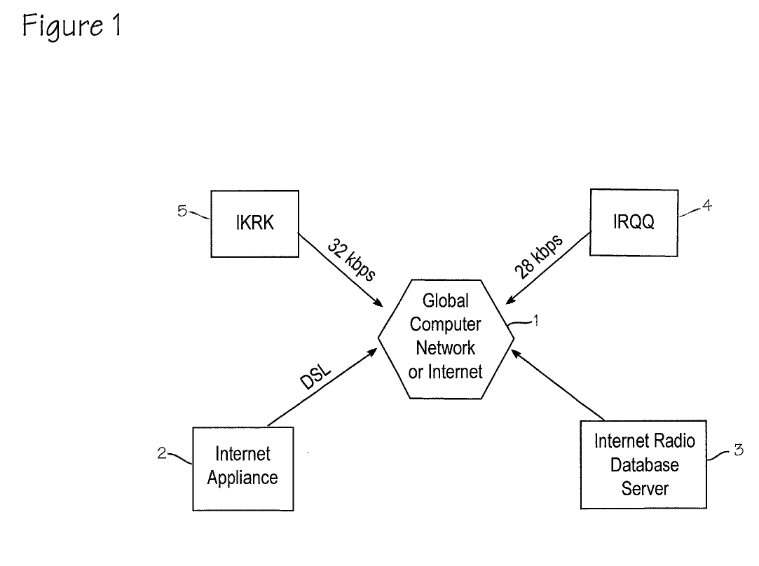

FIG. 1 is a block diagram of the system. The system is comprised of a global network of computers 1, an internet appliance or client device 2, an internet media database server 3, and individual media content servers, here shown as radio station server IRQQ 4 and radio station server IKRK 5.

The global network of computers 1 is preferably the Internet. However, a wide area network, intranet, LAN, or other types of networks may make use of the system. The global network of computers allows for communication between computers such as the internet appliance 2, the media content database server 3, and radio station servers IRQQ 4 and IKRK 5.

The internet appliance or client device 2 is the user interface whereby the user can select the desired internet media content source by simply tuning it in. Some internet appliances are capable of receiving and outputting audio content like a tradition radio receiver, while others are capable of receiving and outputting audiovisual content. We describe an internet appliance in our co-pending application Internet Radio Receiver and Interface, U.S. application Ser. No. 09/334,846, which is incorporated herein in its entirety. Internet Radio Receiver and Interface describes devices and method for receiving radio broadcasts (webcasts) over the internet 1 in a device that resembles a typical radio receiver. The hardware is housed in a radio box separate from a personal computer, and the interface is a panel of physical radio knobs, buttons, FM and AM channel indicators, etc., on the radio housing. Inside the radio box, necessary computer components and software permit connection to the internet and communication with various sources of audio content. In one embodiment, the device is a completely standalone device that a consumer can plug into a telephone line, ISDN line, local area network, or cable line and select radio stations with the same type of controls as a typical radio. In another embodiment, the device is a box that communicates with the internet through the user's personal computer, which must then have an internet connection and internet software installed and operating. In third and fourth embodiments, the internet appliance is either a personal computer or a web TV with the necessary browser software, audio processing software, and radio simile graphical interface.

The media content database server 3 stores information and disseminates the information to the internet appliance 2 over the internet 1. The database server processes the user's requests and is the primary interface to the internet appliance. In our example, the database server maintains internet radio station information, including a list of stations (audio content providers), their streaming audio format, bit rate, and associated URL. The database server could maintain a list of pre-rolls (as described in System and Method for Limiting Dead Air Time in Internet Streaming Media Delivery, U.S. application Ser. No. 09/570,837), advertisements, or other audio clips. The database server communicates with the internet appliance to identify the connection rate of the internet appliance to the global network of computers (56K, ISDN, DSL for example) and identify the streaming audio format the user's audio player requires (streaming MP3 for example).

Also connected to the internet are a plurality of media content servers. In our example, the media content servers are internet radio station servers, with each radio station server corresponding to a radio station with a call letter, here radio station server IRQQ 4 and IKRK 5. Each of these radio station servers can be coupled directly to the global network of computers 1. At the radio station server, the audio information is converted into a digital stream format for transmission through the global network of computers. The audio data is provided through streaming audio software that provides the audio data to users requesting a connection to the audio data. Internet radio station servers can currently transmit or stream the audio data at different bit rates. For example, radio station server IRQQ is streaming at the bit rate of 128 kbps while radio station server IKRK is streaming at 32 kbps. Other common audio streaming bit rates include 16 kbps and 64 kbps.

When the user selects an internet radio station, the internet appliance 2 sends a request to the internet radio database server 3. The internet radio database server responds with the URL of the internet radio station server the user wants to play and the instructions that tell what internet appliance audio processing software is required to play the requested audio content. The internet appliance, the database server, and the radio station server negotiate to arrange the transmission of streaming audio content to the user. In most instances, the requested audio content has been compressed and encoded.

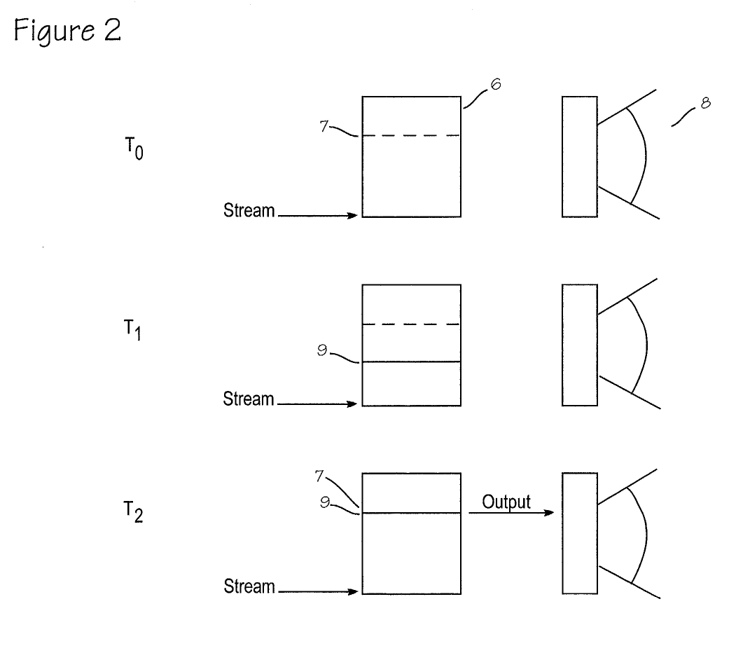

FIG. 2 illustrates the streaming media/audio buffering process. The requested audio stream is transmitted in “packets” of compressed audio to a play buffer 6 on the internet appliance 2. A play buffer is an area of memory for temporarily storing the packets before the packets are transferred for outputting. The size of the play buffer generally ranges from 5 Kilobytes (KB) up to several hundred KB (or more). Once the play buffer is filled to a predetermined level of audio data (also called the “low-water mark”) 7, the internet appliance starts to decompress, decode and output the audio data at the head of the play buffer through an audio output device 8 on the internet appliance; i.e. play the audio (the internet appliance can have an audiovisual output device if the appliance can receive audiovisual data). The low water mark triggers the outputting process. At T0, the buffering process begins. At T1, the play buffer is filled to level 9. At this level, outputting has not commenced. At T2, the play buffer is filled to the low water mark, triggering the output process. The internet appliance begins to output from the head of the play buffer while continuing to buffer to the tail of the play buffer. Once the audio data at the head of the buffer is played, it is lost or discarded from the buffer to make room for new audio data packets being transmitted. Ideally, the streaming process provides an uninterrupted stream of audio to the audio device.

The internet appliance 2 is set with a constant buffering time. In our example, the constant buffering time is set at four (4) seconds. However, the constant buffering time can be set for other lengths of time. Based upon the bit rate of the stream, the internet appliance is programmed to adjust the low water mark 7 of the play buffer 6 to a level such that the time for buffering to the low water mark remains at the constant buffering time (4 seconds). Regardless of the bit rate of the stream, the time for buffering to the low water mark remains constant.

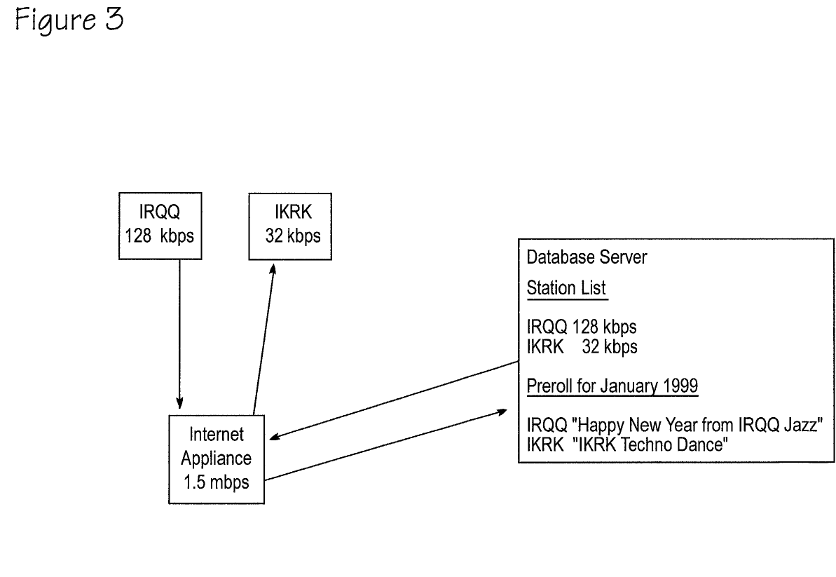

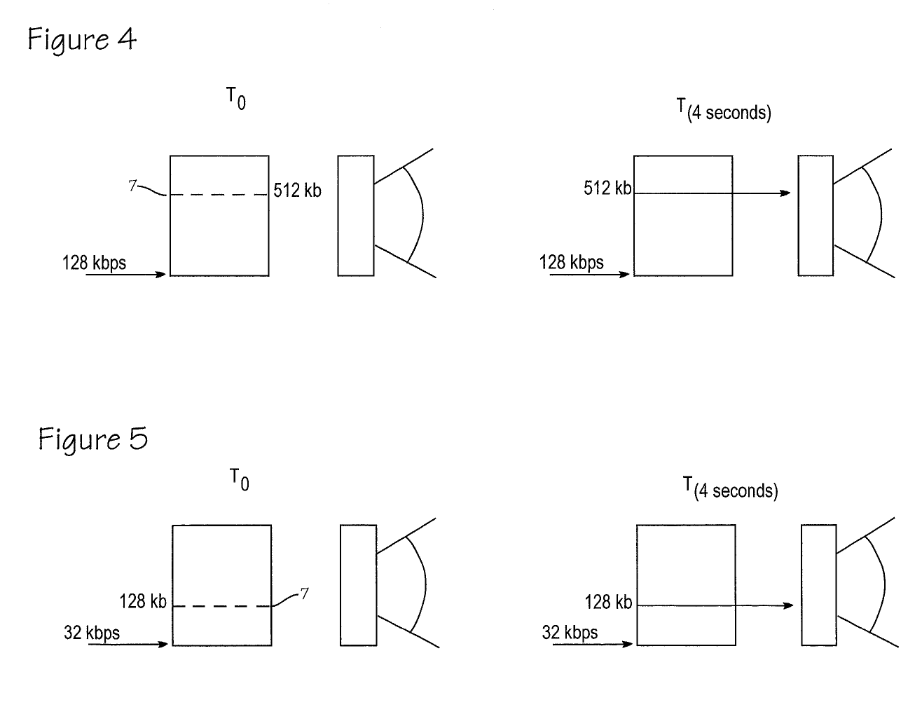

FIGS. 3 through 4 illustrate the system of FIG. 1 in use. As illustrated in FIG. 3, when the user turns on the internet appliance 2, the internet appliance negotiates connection with the internet radio database server 3 through the internet 1. The connection rate of the internet appliance to the internet depends upon the connection hardware (modem). FIG. 3 illustrates the internet appliance connecting with a DSL modem and line at 1.5 Mbps. The user selects the first radio station server IRQQ 4, and the internet appliance requests connection with server IRQQ. The database server receives the request for server IRQQ from the internet appliance and matches the request with information about server IRQQ stored in the database server. The database server then transmits information for connection with server IRQQ to the internet appliance. Once the internet appliance has negotiated with server IRQQ, server IRQQ begins to stream data to the internet appliance, here at 128 kbps.

Once negotiation with radio station server IRQQ 4 has been established, server IRQQ begins streaming audio data directly to the play buffer 6 at 128 kbps. FIG. 4 is a simplified diagram of the system adjusting the low water mark 7 of the play buffer. The internet appliance is programmed to identify the bit rate of the stream from server IRQQ. The internet appliance then adjusts the low water mark based upon the identified bit rate. The internet appliance adjusts the low water mark to a level so that the time for buffering to the low water mark is at the constant buffering time. As illustrated in FIG. 4, the constant buffering time is preset at 4 seconds. This means that the time that the internet appliance allots to buffering to the low water mark is 4 seconds. With a 128 kbps stream and a four-second buffering time, the internet appliance must adjust the low water mark to 512 kb (kilobits). It would take the internet appliance four seconds to buffer to the low water mark at the 128 kbps stream. When the play buffer is filled to the low-water mark (512 kb), the internet appliance begins outputting the buffered audio data from the head of the play buffer while simultaneously buffering audio data to the tail of the play buffer. The system tries to maintain at least the low-water mark of buffered audio data in the play buffer.

When the user switches from server IRQQ 4 to server IKRK 5, the user then turns the tuning knob (or station selector) to select server IKRK and the internet appliance 2 sends a request for server IKRK to the internet radio database server 3. The database server receives the request for server IKRK from the internet appliance and matches the request with information about server IKRK stored in the database server. The database server then transmits the requested information to the internet appliance. Simultaneously, the internet appliance stops receiving and buffering audio data from server IRQQ and deletes any remaining audio data from station IRQQ still buffered in the play buffer 6.

As shown in FIG. 5, server IKRK 5 is transmitting at 32 kbps. When the database server 3 and the internet appliance 2 successfully negotiate with server IKRK 5, server IRKR begins to stream compressed and encoded audio data packets to the play buffer 6 on the internet appliance at 32 kbps. The internet appliance identifies the bit rate of the stream as 32 kbps. The internet appliance adjusts the low water mark 7 of the play buffer to a level so that the time for buffering to the low water mark is the constant buffering time (4 seconds). At the bit rate of 32 kbps, the software adjusts the low water mark to 128 kb. Based upon the 32 kbps stream, it should take the internet appliance four seconds to buffer to the 128 kb low water mark. When the internet appliance has buffered to the low water mark, the internet appliance begins to output the buffered data at the head of the play buffer to the output device while simultaneously buffering to the tail of the play buffer. The internet appliance tries to maintain the low-water mark of buffered audio data. The internet appliance is now playing a continuous stream of audio from station IKRK.

A benefit of the constant buffering time is that it is constant. The user can expect around four seconds of delay time before audio is heard from the new radio station. Because the buffering delay time is constant and predictable, pre-rolls and other audio clips can be made a standard length of time to fit exactly into the dead air time. Four-second advertisements or other audio clips can be standardized to the four-second spots between station changes.

The standardized pre-rolls or audio clips can be stored on memory in the internet appliance 2 or the database server 3. The pre-rolls can be audio or audiovisual. If the pre-rolls are stored in the internet appliance, the internet appliance recalls the pre-rolls during the buffering process. If the pre-rolls are stored in the database server, the internet appliance requests from the database server the pre-rolls. The database server then provides the internet appliance with the appropriate standardized pre-roll. During station switches and during the buffering process, the internet appliance outputs the pre-rolls. Since the standardized pre-rolls are about the same duration as the buffering time, the user does not experience any silence or dead air time between station switches.

Thus, while the preferred embodiments of the devices and methods have been described in reference to the environment in which they were developed, they are merely illustrative of the principles of the inventions. The devices and methods are adaptable to other forms of media data, including audiovisual media data. Additionally, the four-second constant buffering time described above is merely an illustration of a constant buffering time. The internet appliance can be set with a six second, an eight second, or any other constant buffering time to fit the needs of the user, manufacturer or advertisers. Buffering times could also be constant for each bit rate but vary between bit rates so that 32 kbps streams are buffered for 4 seconds but 320 kbps are buffered for 8 seconds. The fixed buffer time based on bit rate could also vary depending on the type of media so that video media types are buffered for one second but audio streams are buffered for 4 seconds. The times used are approximate, a 4 second buffer means approximately four seconds. Other embodiments and configurations may be devised without departing from the spirit of the inventions and the scope of the appended claims.

We claim:

1. A system for buffering streaming media data in a client device, said client device capable of coupling to a plurality of media content servers through a global network of computers, said plurality of media content servers providing said streaming media data through said global network of computers at a plurality of transmission rates, said client device having a buffer for storing said streaming media data, said client device buffering said streaming media data into said buffer at a buffering duration, said client device having an output device for outputting said streaming media data, said system comprising:
the buffer having a variable low water mark for triggering initial outputting of the streaming media data;
the client device having a constant buffering time;
the client device programmed to perform the following steps:
identifying the transmission rate of the media content server selectively connected to the client device; and
setting the variable low water mark to a level based upon the transmission rate so that the buffering duration is about the constant buffering time.

2. A system for buffering streaming media data in a client device, said client device capable of coupling to a plurality of media content servers through a global network of computers, said plurality of media content servers providing said streaming media data through said global network of computers at a plurality of transmission rates, said client device having a buffer for storing said streaming media data, said client device buffering said streaming media data into said buffer at a buffering duration, said client device having an output device for outputting said streaming media data, said system comprising:
the buffer having a variable low water mark for triggering initial outputting of the streaming media data;
the client device programmed to perform the following steps:
identifying the transmission rate of the media content server selectively connected to the client device; and
setting the variable low water mark to a level based upon the transmission rate.

3. The system of claim 2, wherein said system further comprising a constant buffering time, wherein the buffering duration is about said constant buffering time.

4. A method for buffering streaming media data from a selected media content server of a plurality of media content servers to a buffer residing in a client device, said selected media content server providing said streaming media data at a transmission rate, said client device having an output device for outputting said streaming media data, said method comprising the following steps:
providing the buffer with a variable low water mark for triggering initial output of the streaming media data to the output device, the client device buffering said streaming media data into said buffer to the low water mark at a buffering duration;
identifying the transmission rate of the selected media content server; and
setting the variable low water mark to a level based upon the transmission rate.

5. The method of claim 4, wherein said method further comprising the step of providing a constant buffering time, wherein the buffering duration is about said constant buffering time.

6. A method for buffering streaming media data from a selected media content server of a plurality of media content servers to a buffer residing in a client device, said selected media content server providing said streaming media data at a transmission rate, said client device having an output device for outputting said streaming media data, said method comprising the following steps:
providing the buffer with a variable low water mark for triggering initial output of the streaming media data to the output device, the client device buffering said streaming media data into said buffer to the low water mark at a buffering duration;
providing a constant buffering time;
identifying the transmission rate of the selected media content server; and
setting the variable low water mark to a level based upon the transmission rate so that the buffering duration is about the constant buffering time.

7. A system for receiving and playing streaming media data on a client device connected to a global network of computers, wherein a plurality of media servers are coupled to the global network of computers, said plurality of audio servers being capable of transmitting the streaming media data through the global network of computers at a plurality of transmission rates; and wherein the client device is capable of communicating with the media servers through the global network of computers, said client device having an output device for outputting the streaming media data, said client device having a buffer for storing the streaming media data, said system comprising:
the client device having memory, audiovisual outputs, and selectively operable streaming media input connections;
said client device programmed to selectively establish connection with media servers among the plurality of media servers; and also programmed to establish a buffer within the client device for buffering streaming media data from a media server, and further establishing a low water mark within the buffer, said low water mark representing an amount of data which is to be received and stored in memory from the media server prior to initiating output of the streaming media data to an output device, said client device further programmed to vary the low water mark of the buffer depending on the transmission rate of the particular media server to which the client device is connected.

8. The system of claim 7, wherein the client device is further programmed to set the low water mark of the buffer depending on the transmission rate so as to limit the time required to buffer to the low water mark to a predetermined time period.

9. The system of claim 7, wherein the client device is further programmed to set the low water mark of the buffer depending on the transmission rate through the following steps:
identifying the transmission rate of the media server to which the client device is connecting; and
setting the low water mark to a level based upon the transmission rate so that the time period required for buffering is approximately constant upon connection to any of the plurality of media servers.

10. The system of claim 8 further comprising:
a source of audio content clips, each said clip being approximately the same length as the time required to buffer to the low water mark, wherein the client device is programmed to output said clip during the time period required for buffering.

11. The system of claim 9 further comprising:
a source of audio content clips, the time required to play each said clip is approximately the same time period required for buffering.

12. The system of claim 10 or 11, wherein the clips are stored on a media database server connected to the global computer network.

13. The system of claim 10 or 11, wherein the clips are stored in memory on the client device.
